(19) United States
(12) Patent Application Publication
(10) Pub. No.: US 2006/0187851 A1
(43) Pub. Date: Aug. 24, 2006

(54) Method and apparatus for evaluating network usage

(76) Inventors: Michelle M. Waldorf, Plainfield, IL (US); Graham P. Rousell, Banbury (GB); Erin Baker, Singapore (SG)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/302,316

(22) Filed: Dec. 12, 2005

Related U.S. Application Data
(60) Provisional application No. 60/654,287, filed on Feb. 18, 2005.

(51) Int. Cl. H04J 1/16

(52) U.S. Cl. 370/252

(57) ABSTRACT

A method and system of evaluating network usage among signals experiencing varying enhancements or impairments collects data of network communications signals, which may describe parameters relating to the quality of the signal, such as noise level or echo level. Data is also collected describing the behavior of the callers using those signals, such as call duration. The system then correlates the signal data with the behavior data in order to determine how signal quality affects the duration or frequency of communications. As a result, network usage may be evaluated in an objective manner that may also be directly relevant to network revenue.

### RELATED APPLICATION

This application claims the benefit of U.S. Provisional Application No. 60/654,287, filed on Feb. 18, 2005, and the U.S. Provisional Application by Graham P. Rousell et al. filed on Dec. 8, 2005 having Attorney docket no. 2376.2043-002 entitled “Methods for Measuring Voice Quality.” The entire teachings of the above applications are incorporated herein by reference.

### BACKGROUND OF THE INVENTION

An existing method for measuring voice quality assigns mean opinion scores (MOS) related to speech heard on a communications circuit. Typically, in assigning a MOS, a numerical measure of quality of human speech, in the form of subjective tests or opinionated scores, is measured at the destination end of a communications circuit. For example, a subjective test can involve asking a group of listeners to rate quality of test sentences read aloud over the communications circuit by male and female speakers. Each listener then gives each sentence a rating, such as: 1 (bad); 2 (poor); 3 (fair); 4 (good); 5 (excellent). An arithmetic mean of all of the individual scores is then calculated.

Another existing method for measuring voice quality uses a perceptual evaluation of speech quality (PESQ) algorithm, which calculates MOS without using human participants, and is typically performed in a laboratory environment.

### SUMMARY OF THE INVENTION

An embodiment of the present invention includes a system, or corresponding method, of evaluating network usage. The system collects data of network communications signals, which may describe parameters relating to quality of the network communications signals, such as noise level or echo level. Data describing the behavior of the callers using those signals, such as call duration, is also collected. The system then correlates the signal data with the behavior data in order to determine how signal quality affects the duration or frequency of communications. As a result, embodiments of the present invention may evaluate network usage in an objective manner.

The technique described above for evaluating network usage may be applied to a service provider's network to measure behavior data of a test group and a control group on the service provider's network. In this way, a signal enhancement system may be marketed to the service provider in part by informing the service provider of a difference between the behavior data of the test group and the behavior data of the control group due to the signal enhancement system as applied to the service provider's network.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is an illustration of an exemplary embodiment of the present invention.

FIG. 1B is a flow diagram depicting a process of the embodiment of FIG. 1A.

FIG. 2-4 are block diagrams illustrating exemplary embodiments of the present invention.

FIGS. 5-9 are data charts illustrating results of an exemplary embodiment of the present invention.

FIG. 10 is a diagram illustrating how an exemplary embodiment of the present invention may be used to market voice quality enhancement systems.

FIG. 11 is a flow diagram of an example process for collecting and analyzing the call data.

### DETAILED DESCRIPTION OF THE INVENTION

A description of preferred embodiments of the invention follows.

An embodiment of the present invention measures the effect voice quality has on consumer behavior. Unlike measuring voice quality by taking mean opinion scores (MOS), embodiments of the present invention avoid qualitative measurement of voice quality. Unlike measuring voice quality using a perceptual evaluation of speech quality (PESQ) algorithm, embodiments of the present invention can take actual quantitative measurements of consumer behavior for calls made in a communications network.

Embodiments of the present invention can measure voice quality by measuring parameters in an actual consumer use environment and can use experimental research and statistical analysis to non-intrusively measure the voice quality. As a result, some embodiments of the present invention can take into consideration factors affecting voice quality, including voice quality impairments (such as echo) or voice quality improvements (such as echo cancellation).

In an exemplary embodiment of the present invention, call duration (CD), the duration between the start and end of a call, is measured. One reason to correlate voice quality to call duration is that, if a caller (i.e., customer or consumer) is not satisfied with the voice quality of the current call, the caller will likely quickly end the call. Furthermore, if the caller is using a mobile phone, the caller will likely end the call and redial on a wireline phone.

Another reason for correlating voice quality to call duration is that factors, such as speech level, low signal-to-noise ratio, acoustic echo, hybrid echo, coding distortion, and circuit delay, can have an impact on call duration. Therefore, an embodiment of the present invention can be helpful to determine an impact on voice quality due to a change in a communications network, such as an addition of an echo canceller or voice quality enhancement product or feature (EC/VQE) to a communications network. Examples of EC/VQE include a mobile telephone adapter, telephone adapter, hybrid echo control, acoustic echo control, noise suppression, noise reduction, or level control.

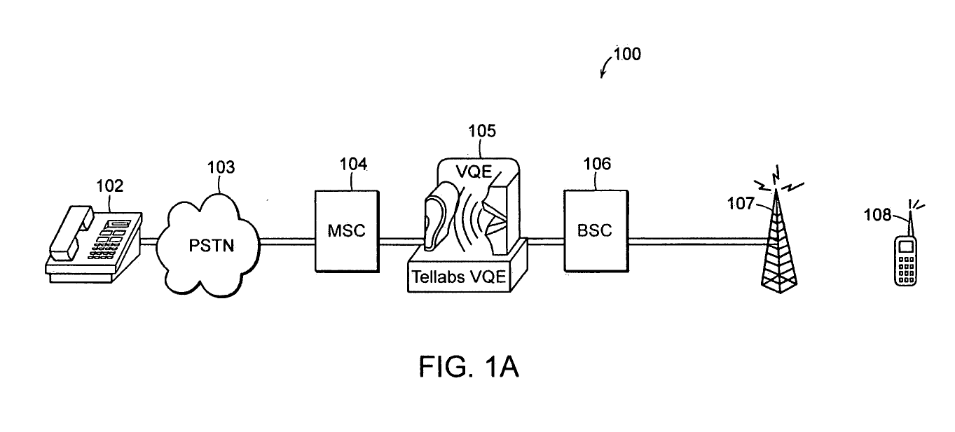

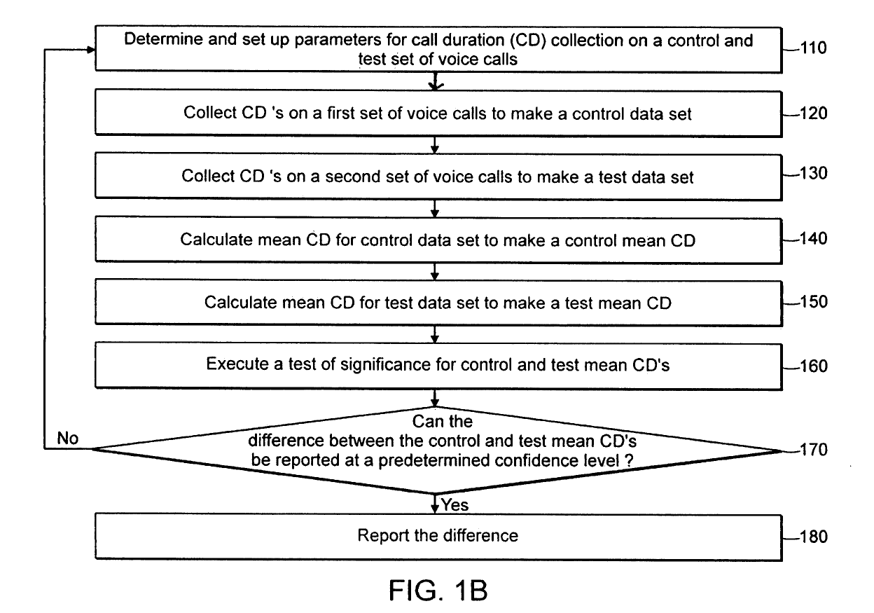

FIG. 1A illustrates a typical communications system 100 to which an embodiment of the present invention may be applied. Two users, one operating a telephone 102 and the other operating a mobile phone 108, communicate with one another through a network of several network elements. The telephone 102 connects by stationary wire to a public switched telephone network (PSTN) 103, which sends communications signals to a mobile switching center (MSC) 104. Between the MSC and a base station controller (BSC) 106, the signals pass through a voice quality enhancement (VQE) system 105, which applies one or more signal enhancements, such as noise reduction or acoustic echo cancellation, to the signal to enhance sound quality for the end user operating the mobile phone 108. The enhanced signals then pass to an antenna tower 107, which transmits the signal to the mobile phone 108. Likewise, the user operating the mobile phone 108 may transmit signals through the same network, resulting in signals enhanced by the VQE system 105 for enhanced voice quality at the telephone 102.

Enhanced voice or sound quality may increase an amount of time that callers use a phone service, thereby increasing revenue for the phone service provider. While the system 100 improves sound quality through use of the VQE 105, the system 100 alone cannot determine whether this improvement actually results in increased call duration or increased revenue over systems without VQE. Embodiments of the present invention provide a way to determine how differences in signal quality affect caller behavior, allowing service providers to see the results of enhancement systems in terms of caller data that directly affect revenue.

It should be understood that the communications system 100 may be a 2G mobile network, 3G mobile network, include voice-over-Internet Protocol (VoIP), or include any combination of present or future communication systems, subsystems, protocols, and so forth.

FIG. 1B illustrates, in the form of a flow diagram, an exemplary embodiment of the present invention. It should, however, be evident that various modifications and changes may be made thereto without departing from the broader spirit and scope of the present invention. For example, some of the illustrated flow diagrams may be performed in an order other than that which is described. It should be appreciated that not all of the illustrated flow diagrams is required to be performed, that additional flow diagram(s) may be added, and that some may be substituted with other flow diagram(s).

The embodiment of FIG. 1B collects call durations for a sampling of voice calls to make a control data set and collects call durations for a sampling of voice calls to make a test data set. In the control data set, call durations are collected on channels where there is no EC/VQE, and in the test data set, call durations are collected on channels where there is EC/VQE.

Parameters for call duration collection on a control and test set of voice calls are determined and set-up (element 110). Depending upon what voice quality conclusions or effects of EC/VQE are to be reported, parameters can be selected from one or more of the following or similar parameters: voice call impairment(s), EC/VQE application(s), time, location of the voice calls, network element transmitting or receiving the voice calls, and number of voice calls.

The control and test sets of voice calls are preferably gathered at the same time and location to eliminate effects of time and location on call duration. In this way, effects of EC/VQE equipment, or other equipment is accurately assessed.

Regarding the parameter of voice call impairment(s), call durations can be collected on voice calls having one or more impairments, such as calls with objectionable acoustic echo, calls with low level uplink, calls with low level downlink, calls with high level uplink, calls with high levels downlink, and calls with high background noise.

Regarding the parameter of EC/VQE application(s), call durations can be collected on a control set of voice calls where a particular EC/VQE application is not used (element 120), and call durations can be collected on a test set of voice calls where one or more particular EC/VQE applications are used (e.g., mobile telephone adapter, telephone adapter, hybrid echo control, acoustic echo control, noise suppression, noise reduction, or level control) (element 130).

Regarding the parameter of time, the time can be at a certain time (e.g., morning, afternoon, evening, particular time during a business day) or on a certain day (e.g., business day, holiday, weekend day, or particular day of the week) or days (e.g., a one week period, a one month period).

Regarding the parameters of location of the voice call and network elements transmitting or receiving the voice calls, location can be, for example, a particular site (e.g., a business location or particular place within a city) or a particular area (e.g., residential area, business area, town, metropolitan area, or part of a metropolitan area).

Location of call duration collection can be anywhere on a network, such as where voice calls are transmitted or where EC/VQE may be employed. For example, call durations can be collected on channels on transmission links, such as types T1, E1, T3, E3, OC-3, and STM-1. Furthermore, call durations can be collected on transmission links between network elements or within a network element, and the communications network may be a wireline or wireless network.

After collection of call durations on the control and test set of voice calls is made and control and test data sets are made, a mean (i.e., average) call duration for the control data set is calculated to determine a control mean call duration (element 140). Similarly, a mean call duration for the test data set is calculated to determine a test mean call duration (element 150). A test of significance is then executed for the control and test mean call durations (element 160). If a difference between the control and test mean call durations can be reported at a predetermined confidence level, such as 95% confidence (element 170), the difference is reported (element 180). Otherwise, additional collection and calculations are performed (elements 110-160) until the difference between the control and test mean call durations can be reported at the predetermined confidence level (element 170). It should be understood that if the difference does not achieve a predetermined confidence level within a given time frame, collection of the call durations may be reconsidered and moved from the location(s) the collection is performed to different location(s).

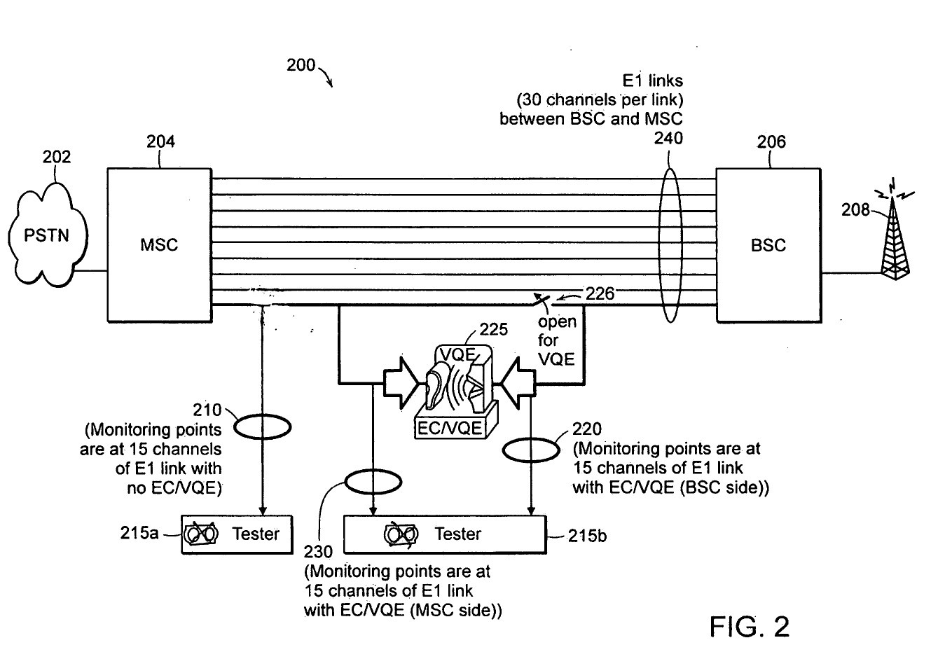

Elements 120-180 are briefly described again below following discussion of FIGS. 2-4, which provide physical context for the flow diagram of FIG. 1.

FIGS. 2-4 illustrate exemplary embodiments of the present invention, where various parameters are selected that relate to location of the voice call and network elements transmitting or receiving the voice calls.

FIG. 2 illustrates placement of data collection device(s) (“tester(s)”) 215a, 215b in a network 200 where call durations can be collected by at least one tester 215a, 215b, according to an exemplary embodiment. The tester(s) 215a, 215b may be a single, unit, two units, or more than two units. As understood in the art of multiple units, the tester(s) 215a, 215b are calibrated or use certain signals on the links 240 that can be used to ensure data collected on one tester 215a is captured at essentially the same level(s) as on another tester 215b. The tester(s) 215a, 215b may be physically moved to collect data from different locations on the network 200, or the tester(s) 215a, 215b may be connected to the network 200 at a fixed location and have network connections switched or otherwise configured to allow the tester(s) 215a, 215b to receive communications to make the measurements.

FIG. 2 further shows multiple transmission links (e.g., E1 transmission links) between a first network element (e.g., a mobile switching center (MSC)) 204, which is connected to a public switched telephone network 202, and a second network element (e.g., a base station controller (BSC)) 206, which is connected to an antenna tower 208. An MSC provides services between mobile users in a network and external networks. A BSC manages radio resources in global system for mobile communications (GSM) for specified cells within a public land mobile network (PLMN).

Each transmission link 240 carries a particular number of channels. For example, an E1 transmission link carries up to thirty voice channels. For the control data set, call durations can be collected via test link 210 connected to a number of channels that do not have EC/VQE 225 and that are on a particular transmission link. For example, for the control data set, call durations can be collected on fifteen of the thirty channels of a particular E1 transmission link. For the test data set, call durations are collected via test links 220 and 230 connected to a number of channels that have EC/VQE 225, with a switch 226 or the like to enable introduction of signal(s) processed by the EC/VQE 225 onto respective channels, and that are on the same transmission link. For example, for the test data set, call durations can be collected on the other fifteen of the thirty channels on the same E1 transmission link on which the control data set is collected. In this embodiment, since the mean of the data samples are used instead of sums, there is no need to adjust the sample sets due to the difference in number of channels used in each sample.

Within a transmission link, channels can be designated for the control data set or the test data set in various ways. In one way, of all the channels on a particular transmission link, one half of the channels can be designated for the control data set, the other half of the channels can be designated for the test data set, and the channel designations can be interleaved or alternated. For example, for an exemplary embodiment of thirty channels on an E1 transmission link, the even numbered channels can be designated for the control data set, and the odd numbered channels can be designated for the test data set. Another way of designating channels on a transmission link is that the channels on a particular transmission link can be randomly designated for each of the control and test data sets. Yet another way of designating channels is that the first half of the channels on a transmission link (e.g., channels numbered 1-15 of the thirty channels on an E1 transmission link) can be designated for the control data set and the second half of the channels (e.g., channels numbered 16-30 of the 30 channels on the same E1 transmission link) can be designated for the test data set.

In some E1 links, channel numbers 1-15 and 17-30 are communications channels, and channel number 16 is a signaling channel. In such a situation the control channels or test channels may be fourteen and fifteen channels, respectively. Since averaging is used, the difference has negligible effect.

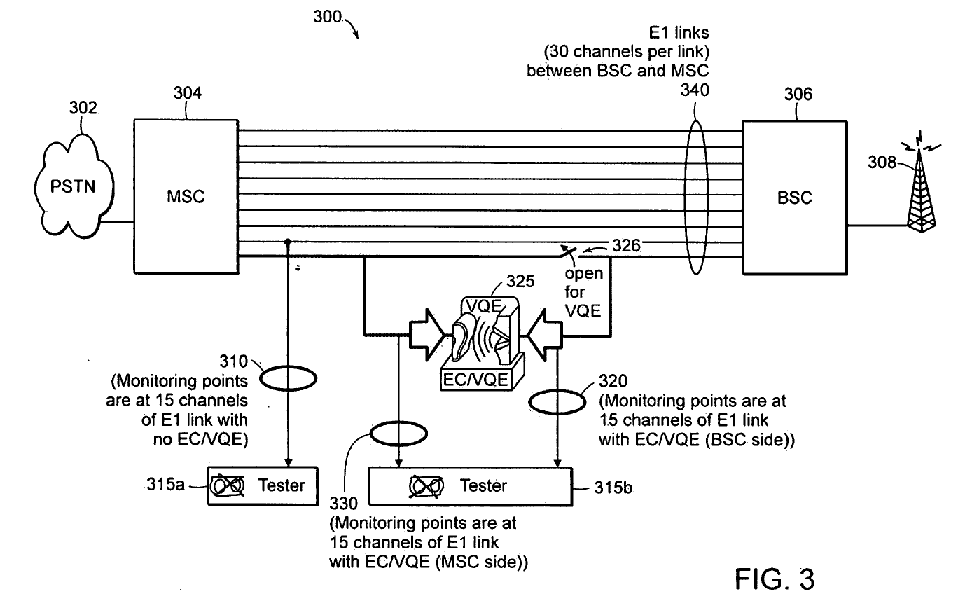

FIG. 3 illustrates placement in a network 300 where call durations can be collected, according to another exemplary embodiment. FIG. 3 shows multiple transmission links (e.g., E1 transmission links 340) between a first network element (e.g., an MSC 304 connected to a subnetwork (e.g., PSTN) 302) and a second network element (e.g., a BSC). In this exemplary embodiment, for the control data set, call durations are collected at point 310 on a number channels that do not have EC/VQE and that are on a particular transmission link. For example, for the control data set, call durations can be collected on fifteen of the thirty channels of a particular E1 transmission link. For the test data set, call durations are collected via test links 320 and 330 connected to a number of channels that have EC/VQE 325 operating on them, via a switch 326 or other technique for applying signals from the EC/VQE onto the channels, and that are on a different transmission link. For example, for the test data set, call durations can be collected on the fifteen of the thirty channels on a different E1 transmission link. Therefore, FIG. 3 illustrates that call durations can be collected on one or more transmission links between two network elements.

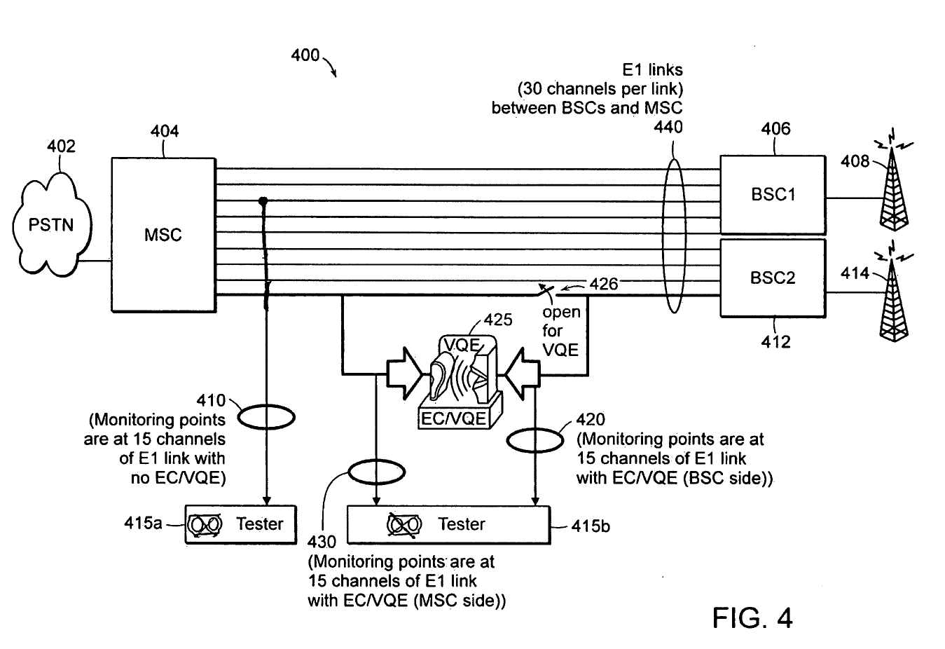

FIG. 4 illustrates placement in a network 400 where call durations can be collected, according to yet another exemplary embodiment. FIG. 4 shows multiple transmission links (e.g., E1 transmission links) 440 between multiple network elements (e.g., an MSC 404 and two BSCs 406, 412) connected to a subnetwork (e.g., PSTN) 402 and antenna towers 408, 414, respectively. In this exemplary embodiment, for the control data set, call durations are collected via test link 410 connected to a number channels that do not have EC/VQE and that are on a particular transmission link connected to a particular BSC 406, 412. For example, for the control data set, call durations can be collected on fifteen of the thirty channels of a particular E1 transmission link, which is connected to BSC1 1406. For the test data set, call durations are collected via test links 420 and 430 connected to a number of channels that have EC/VQE 425 and a corresponding switch 426 and that are on a different transmission link connected to a different BSC. For example, for the test data set, call durations can be collected on the fifteen of the thirty channels on a different E1 transmission link, which is connected to BSC2 412. Therefore, FIG. 4 illustrates that call durations can be collected on one or more transmission links connected to different and multiple network elements.

With a physical understanding of data collection configurations, reference is made again to FIG. 1B. At element 120, call durations are collected on one or more communications circuits to make a control data set. For example, call durations for 100,000 calls are collected on fifteen voice channels, each channel having no EC/VQE.

At element 130, call durations are collected on the one or more communication circuits to make a test data set. For example, call durations for 100,000 calls are collected on fifteen voice channels, each channel having EC/VQE.

At element 140, a mean (i.e., average) call duration is calculated for the control data set. A mean call duration can be calculated using existing mean calculation methods. For example, mean can be calculated as: mean call duration x′=Σx*f(x), where x is call duration and f(x)=instances of x test call durations/actual sample size n.

At element 150, the mean call duration is calculated for the test data set.

At element 160, a test of significance is executed for the control and test mean call durations. The test of significance used can be an existing test of significance method. For example, a test of significance that can be used is as follows:

$$z = \frac{( {\overline{x}}_{1} - {\overline{x}}_{2} ) - ( {μ}_{1} - {μ}_{2} )}{\sqrt{\frac{{σ}_{1}^{2}}{{n}_{1}} + \frac{ {σ}_{ 2}^{ 2}}{ {n}_{ 2}}}} \qquad ( Equation 1 )$$

where z is a two-sample z statistic (e.g., value of 1.645 when a confidence level of 95% is desired), x₁ and x₂ are the control and test mean call durations (i.e., samples representing characteristics of the entire population of voice calls), μ₁ and μ₂ are unknown means of the entire population of voice calls, σ₁ and σ₂ are the standard deviations of the control and test mean call durations, and n₁ and n₂ are the number of voice calls (actual sample sizes). The standard deviation can be calculated as: standard deviation σ=sqrt((x′−x)²*f(x)), where x is call duration, f(x)=instances of x test call durations/actual sample size n. This test of significance begins with a null hypothesis Ho: μ₁−μ₂=0 and, accordingly, (μ_{1-μ}₂)is set to zero. U.S. Provisional Application No. 60/654,287, the entire teachings of which are incorporated herein by reference, includes additional information regarding tests of significance.

Continuing to refer to FIG. 1B, at element 170, results of the test of significance are compared against a predetermined confidence level to determine a difference between the control and test mean call durations and can be reported at the predetermined confidence level. For example, after inputting x₁, x₂, (μ₁−μ₂), σ₁, σ₂, n₁ and n₂ into Equation 1, the outcome can be z=1.6. The outcome 1.6 can be compared against a value of z for a predetermined confidence level (e.g., a value of z should be 1.645 when a confidence level of 95% is desired). If the difference cannot be reported at the predetermined confidence level, the next element is element 110, where the parameters for call duration collection are adjusted or re-determined and set-up. For example, the number of voice calls for call duration collection can be increased to take a larger sampling of voice calls (n₁ and n₂). If in element 170 the difference between the control and test mean call durations can be reported at a predetermined confidence level, the next element is element 180, where the difference between the control and test mean call duration is reported. The difference between the control and test mean call duration against a confidence level may be reported graphically, as a metric, in tabular form, electronically, or in any other manner understood in the art.

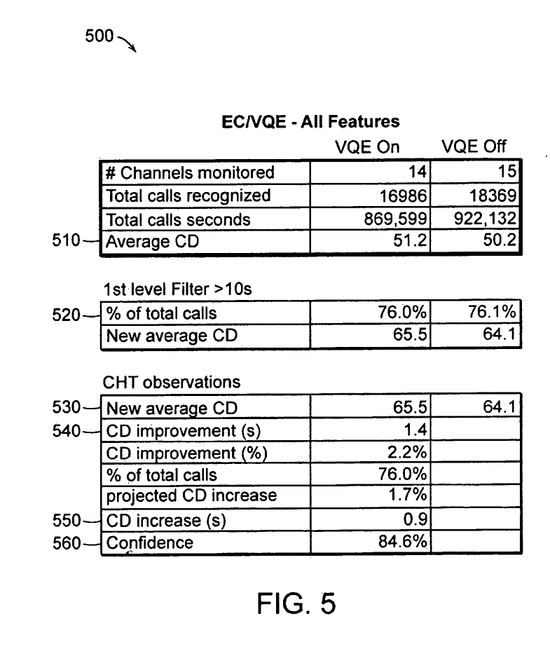

FIGS. 5-9 illustrate reporting of exemplary results, according to various exemplary embodiments of the present invention, having various parameters for call duration collection. The charts compare two sets of calls; in each FIG. the left column provides data of calls passed through a VQE system, and the right column provides data of calls with no voice enhancement through the VQE system. FIGS. 5-9 utilize the same data set of approximately 35,000 calls, as shown in the uppermost box, and analyze the effects of individual voice enhancers on call duration. FIGS. 5-9 are described immediately below, in turn.

FIG. 5 is a chart 500 depicting exemplary results when multiple EC/VQE functions are applied to a network. Among all sampled calls, the average call duration 510 of calls with VQE is shown to be 0.9 s higher than calls without VQE. In this example, a first-level filter eliminates all calls under 10 s because such calls are probably not long enough for voice quality to affect call duration. Such shorter calls may include calls that are not answered, calls with short or incomplete handovers, or calls where a voicemail is reached and no message is left. Upon filtering-out such shorter calls to a percentage of total calls 520, a new average call duration 530 is shown. This new average call duration 530 of calls with VQE is notably higher than the average call duration 530 of calls without VQE, resulting in a call duration improvement 540 of 1.4 s. From this data, a call duration increase 550 over all calls can be projected at 0.9 s. As a result, a confidence interval 560 of 84.6% is attained, meaning that the data shows approximately 85% confidence that a positive improvement in call duration is achieved with multiple EC/VQE.

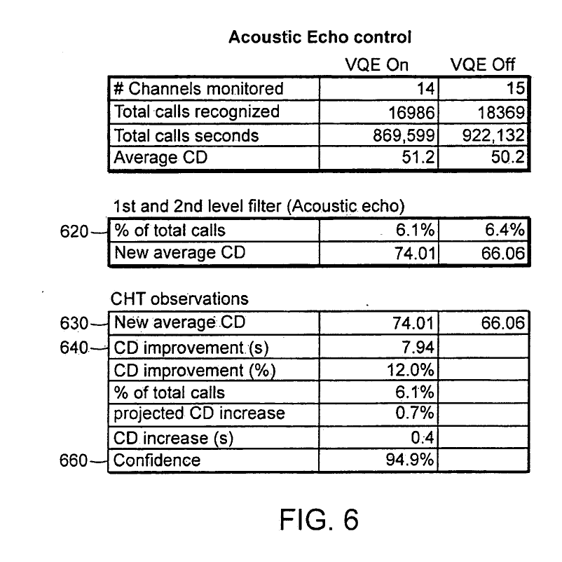

FIG. 6 illustrates exemplary results when a single EC/VQE, acoustic echo control, is applied to a network. Using the same data set as in FIG. 5, a second filter is applied to arrive at a percentage of total calls 620 with acoustic echo control, and a new average call duration 630 is shown. This new average call duration 630 of calls with echo control is notably higher than the new, average, call duration 630 of calls without echo control, resulting in a call duration improvement 640 of 7.94 s. As a result, a confidence interval 660 of approximately 95% (e.g., ±5%, ±1%, ±0.5%) shows that a positive improvement in call duration is almost certainly attained by using acoustic echo control.

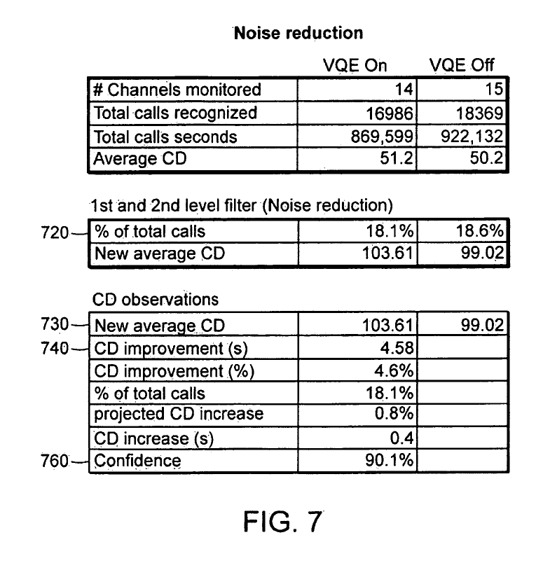

FIG. 7 illustrates exemplary results when a single EC/VQE feature, noise reduction, is applied to a network. Using the same data set as in FIG. 5, a second filter is applied to arrive at a percentage of total calls 720 with noise reduction, and a new average call duration 730 is shown. This new average call duration 730 of calls with noise reduction is notably higher than the new average call duration 730 of calls without noise reduction, resulting in a call duration improvement 740 of 4.58 s. As a result, a confidence interval 760 of 90.1% shows that a positive improvement in call duration is almost certainly attained by using noise reduction.

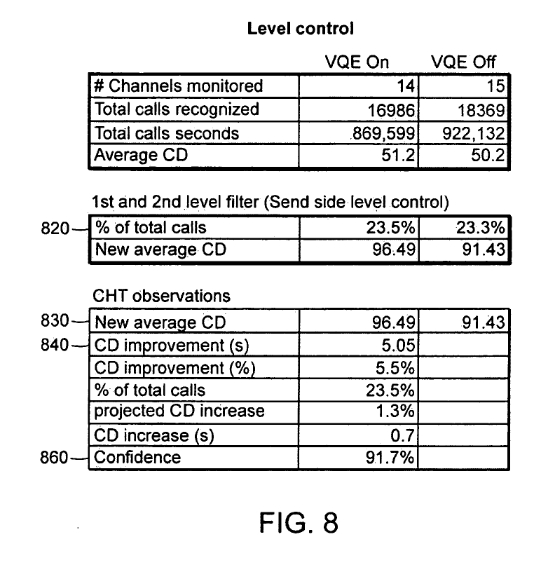

FIG. 8 illustrates exemplary results when a single EC/VQE, level control, is applied to a network. Using the same data set as in FIG. 5, a second filter is applied to arrive at a percentage of total calls 820 with noise reduction, and a new average call duration 830 is shown. This new average call duration 830 of calls with noise reduction is notably higher than the new average call duration 830 of calls without noise reduction, resulting in a call duration improvement 840 of 5.05 s. As a result, a confidence interval 860 of 91.7% shows that a positive improvement in call duration is almost certainly attained by using level control.

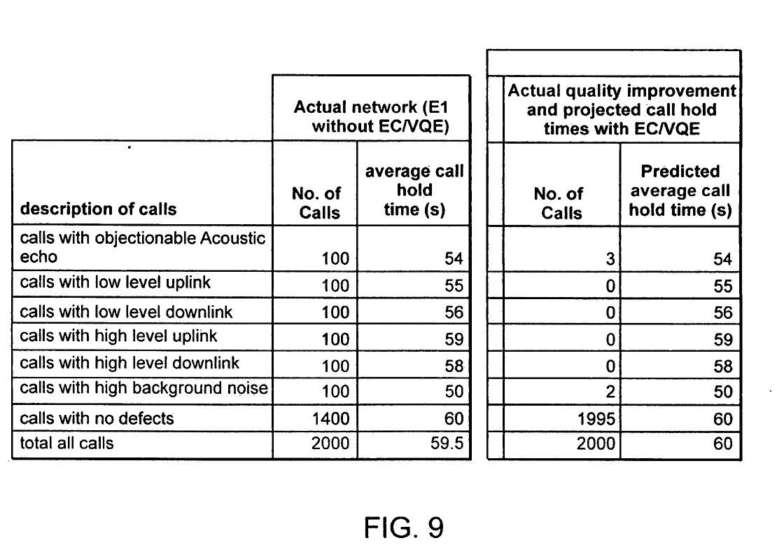

FIG. 9 illustrates exemplary results after (i) breaking-down the control and test data sets into subsets of calls having a particular impairment, such as calls with objectionable acoustic echo, calls with low level uplink, calls with low level downlink, calls with high levels uplink, calls with high levels downlink, calls with high background noise, and (ii) applying an exemplary embodiment of the present invention.

In the foregoing description, the present invention is described with reference to specific example embodiments thereof. It should, however, be evident that various modifications and changes may be made thereto without departing from the broader spirit and scope of the present invention. For example, embodiments of the present invention may be provided as a computer program product, or software, that may include a machine-readable medium having stored thereon instructions. Further, a machine-readable medium may be used to program a computer system or other electronic device, and the readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. The specification and drawings are accordingly to be regarded in an illustrative rather than in a restrictive sense.

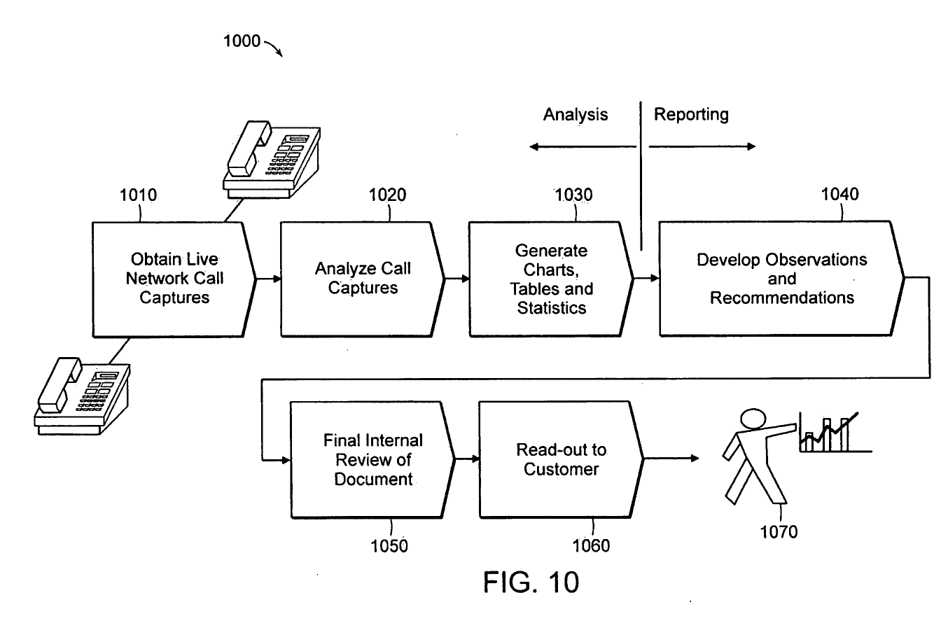

FIG. 10 illustrates a method 1000 for marketing a VQE system to a potential customer, such as a communications service provider, using an embodiment of the present invention. Several calls are captured from a potential customer's network (element 1010), where capturing calls may include recording behavior data, such as call duration, among calls with and without the VQE system. The call data may be analyzed (element 1020) to determine the differences in caller behavior between enhanced and non-enhanced calls. Various charts and other statistics may be generated (element 1030) to illustrate this difference in caller behavior. From these statistics, observations can be drawn (element 1040) about effect(s) of the VQE on the potential customer's network, as well as how to recommend the VQE to the potential customer. These findings may undergo a final internal review (element 1050), and may then presented to the potential customer (elements 1060, 1070).

As a result of this method 1000, marketers of VQE systems may provide service providers with substantial and useful data on the effect of a VQE system on their network. So, for service providers who charge customers on a per minute basis, the marketer of the VQE system can illustrate to a given level of confidence that callers, who keep their calls below a “next calling minute” (e.g., 58 seconds, 1 minute 58 seconds, etc.) without VQE in the network, will likely cross into the next calling minute (e.g., 1 minute 2 second, 2 minutes 2 seconds) if the network is equipped with the VQE systems. Moreover, by applying the VQE system to the service provider's own network and capturing the data as described above, the marketer can sit across a conference table from a service provider executive, for example, and present actual results to the service provider representative to market the VQE system in a convincing manner.

Referring now to details of hardware and software aspects of the tester 215a, 215b, the operation of the tester 215a, 215b is such that the capture process operates unattended and that the analysis process is able to identify and analyze individual call samples within the bulk captures without a requirement of analyzing a signaling channel for call start and stop times.

Analyzing signaling information is the most reliable way of identifying individual call samples; however, this requires a particular protocol to be loaded onto the analyzer, of which there are considerable variants. It is also likely that the signaling channel of interest is in a completely different channel bearer (e.g., wireline or optical fiber) to that being analyzed, and so the mapping of the channel bearers must be known within the signaling channel.

Some embodiments use an approach to analyzing individual calls with a high degree of accuracy by filtering conditions observed within the traffic channels. Embodiments may also analyze what is considered to be the “billable” portion of the call, optionally identifying and removing from the analysis any initial ring tone present before the called party answers.

The end result is determined by comparing two data sets for trend differences, so any errors resulting from mis-identification of calls are equally applied on both sample sets and, therefore, can be ignored.

It should be noted that this process does not require call samples to be “listened to” by the human operator, thereby protecting caller privacy of content passed through the networks.

Given that the network to be analyzed operates with, but need not be limited to, ITU-T G.711 coded signals contained within traffic channels on a multiple channel bearer, typically a G.704/704 E1 or T1 format, the capture engine makes programmed captures of the complete channel bearer. The ability to make captures may be dependent on the use of suitable interface modules between a personal computer (PC) (e.g., tester 215a, 215b) and the telecommunications network, as well as the capability of the PC operating system and disc storage capacity to store individual files of multiple gigabyte size continuously or in multiple captures of shorter duration to the maximum capacity. A capture engine, once programmed, can perform this task unattended.

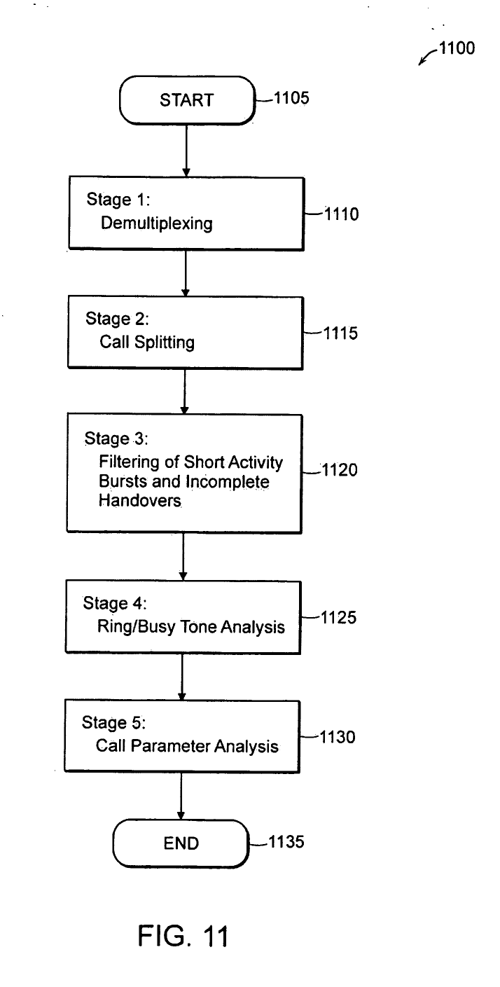

FIG. 11 is a flow diagram of an analysis process 1100, using one embodiment of the present invention, that may use five stages of filtering and analysis to arrive at details pertaining to characteristics of calls within the network. A description below of the analysis process is for one embodiment. It should be understood that other embodiments may also be performed using the same number of stages, more or fewer stages, or other techniques producing the results described above.

Stage 1—Demultiplexing

After the analysis process 1100 starts, a first stage of the analysis process 1100 may extract individual channels from the multiple channel bearer. It is a straightforward division that follows the ITU-T G.703/704 guidelines for frame structure but may equally be applied to any multiple channel bearer. The individual channels (containing multiple call samples) may then be stored into new folders on the PC for further analysis.

Stage 2—Call Splitting 1115

The second stage of the analysis parses each channel capture to identify a start and stop of each call. Identification is primarily conducted with the knowledge that when there is no call activity within a channel, there is a defined “idle code” present in both directions of the channel. A number of idle codes are present in different networks, and the technique of the second stage extracts and stores individual files when one or both sides changes from the defined code for the duration of the change. These changes can be considered calls; however, there are many occasions within general network traffic, especially within mobile networks, when only one side of the circuit may have call activity (due to network handover or call set-up processes) or when callers may try to establish a call but the called party is not present, and, consequently, the call is never established (only ring tone is present). For this reason, further stages of filtering may be applied in the analysis process 1100 to filter-out invalid call conditions.

Stage 3—filtering of Short Activity Bursts and Incomplete Handovers 1120

As a mobile handset user moves from cell to cell, the network tracks and allocates resources in other cells to allow the user to continue the conversation. This movement of tracking and allocating of resources are referred to as “handovers.” Often, the network prepares to provide resources of an available voice channel, only to realize this is not required as the user moves into a different area or the radio quality improves where the user is located. This effect manifests itself as call activity seen on one direction of the transmission path, but no activity in the other direction. The call in the meantime may continue quite satisfactorily within another voice channel and, therefore, is preferably not considered as a call passing over the channel being analyzed.

These samples may, therefore, be analyzed for unidirectional activity for the duration of the stored sample and removed from analysis if there is no activity throughout.

Another consideration is where the handover may take some length of time to complete and, at the end of it, there is only a small amount of bidirectional activity, which is preferably considered of no value in the overall analysis. The technique of stage 3 1120 may provide a means to optimize a minimum amount of bidirectional activity accepted for final analysis as a percentage of the overall file length or in terms of duration in seconds.

Stage 4—Ring/Busy Tone Analysis 1125

A considerable proportion of calls within networks are not established where the user may not be available (continuous ring tone) or are busy on another call (continuous busy tone). These situations are not typically billable and, therefore, may result in skewed data within a call holding time analysis. As an example, a call sample may show that a caller waited for thirty seconds for a call to be answered, and then the caller only spoke for fifteen seconds. The billable time was fifteen seconds; however, the total sample time is seen to be forty-five seconds. This may have a big effect on observed network call duration if it is not taken into account.

Another situation occurs when a call is answered (and billing starts), but then the call is transferred, where a second or further ring tones may be present. It is preferable that these calls, including the transfer, are not removed from any analysis as they are part of the billable time.

The analysis in stage 4 1125 may include a capability to recognize network progress once at the start of a call sample prior to speech activity and can therefore remove the portion with ring-tone from the analysis. This benefits the analysis also because, if the purpose of the analysis is to measure speech level characteristics, they are not being affected by the presence of a ring tone.

By not removing but separately reporting the presence and duration of a ring tone, it is possible to identify if the mobile user originated or received a call. Given that the original captures are made on the mobile network's A-Interface (i.e., a standard interface between the MSC and Transcoder), there is no ring tone present in the mobile set to MSC direction. This is so because the ring tone is generated toward a far end caller by the MSC, yet calls originated by the mobile user have network tones present (as heard by the mobile user). Therefore, it is possible to separate, with a high degree of confidence, mobile originated and mobile received calls within the final analysis.

Stage 5—Call Parameter Analysis 1130

This stage takes each of the call samples resulting from the previous stage's filtering and analyzes them for characteristics affecting call quality, namely: echo—from both the mobile set (acoustic echo) and the network (hybrid or electrical echo), speech levels, noise levels, call duration, and ring/busy tone duration. The resulting output from this can be a spreadsheet or database of data, which can be used for analysis of call characteristics and trends.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of evaluating network usage, comprising:
measuring at least one metric describing impairment of at least one network communications signal;
gathering behavior data of a sample set of calling parties communicating via the at least one network communications signal; and
correlating the behavior data with the at least one metric to evaluate network usage by the calling parties.

2. The method of claim 1 wherein the at least one metric is independent of variables unrelated to impairment of the at least one network communications signal.

3. The method of claim 2 wherein the variables unrelated to impairment of the at least one network communications signal includes at least one of the following:
time of year, time of day, purpose of call.

4. The method of claim 1 wherein the correlating produces results free of human opinion.

5. The method of claim 1 wherein the at least one metric is noise level, speech level, or echo level.

6. The method of claim 1 wherein the behavior data includes call duration.

7. The method of claim 1 wherein the sample set of calling parties includes a test group and a control group of calling parties and wherein gathering behavior data includes conditioning the at least one network communications signal for the test group of calling parties but not the control group of calling parties.

8. The method of claim 7 wherein conditioning the at least one network communications signal includes enhancing signal quality.

9. The method of claim 7 wherein correlating the behavior data with the at least one metric includes comparing behavior data of the test group of calling parties with the behavior data of the control group of calling parties.

10. The method of claim 1 wherein correlating the behavior data of the sample set of calling parties with the at least one metric produces statistically significant results at a confidence level of at least 95%.

11. The method of claim 1 wherein correlating the behavior data with the at least one metric includes correlating the behavior data with an aggregate of a plurality of collected metrics that describe the at least one network communications signal independent of variables unrelated to impairment of the at least one network communications signal.

12. The method of claim 1 wherein correlating the behavior data with the at least one metric includes correlating the behavior data with individual metrics of the at least one metric that describe the at least one network communications signal independent of variables unrelated to impairment of the at least one network communications signal.

13. The method of claim 1 used in a wireless, wireline, or fiber optic communications network.

14. An apparatus for evaluating network usage, comprising:
a measuring module configured to be coupled to at least one network path that, in a coupled state, measures at least one metric describing impairment of at least one network communications signal on the at least one network path;
a gathering module configured to be coupled to the at least one network path that, in a coupled state, gathers behavior data of a sample set of calling parties communicating via the at least one network communications signal; and
a correlation module that is in communication with the collection module and the gathering module, and that correlates the behavior data with the at least one metric to evaluate network usage by the calling parties.

15. The apparatus of claim 14 wherein the at least one metric is independent of variables unrelated to impairment of the at least one network communications signal.

16. The apparatus of claim 15 wherein the variables unrelated to impairment of the at least one network communications signal includes at least one of the following: time of year, time of day, purpose of call.

17. The apparatus of claim 14 wherein output from the correlation module is free of human opinion.

18. The apparatus of claim 14 wherein the at least one metric includes noise level, speech level, or echo level.

19. The apparatus of claim 14 wherein the behavior data includes call duration.

20. The apparatus of claim 14 wherein the sample set of calling parties includes a test group and a control group of calling parties and wherein the gathering module includes a processing module configured to condition the at least one network communications signal for the test group of calling parties but not the control group of calling parties.

21. The apparatus of claim 20 wherein the processing module is configured as a signal quality enhancer.

22. The apparatus of claim 20 wherein the correlation module compares the behavior data of the test group of calling parties with the behavior data of the control group of calling parties.

23. The apparatus of claim 16 wherein the correlation module produces statistically significant results at a confidence level of at least 95%.

24. The apparatus of claim 16 wherein the correlation module correlates the behavior data with an aggregate of a plurality of collected metrics that describe the at least one network communications signal independent of variables unrelated to impairment of the at least one network communications signal.

25. The apparatus of claim 16 wherein the correlation module correlates the behavior data with individual metrics of the at least one metric that describes the at least one network communications signal independent of variables unrelated to impairment of the at least one network communications signal.

26. The apparatus of claim 16 used in a wireless, wireline, or fiber optic communications network.

27. A method of marketing a signal enhancement product to a communications network service provider, the method comprising:
applying a signal enhancement product that performs a signal enhancement process to at least one communications signal for a test group of calling parties but not a control group of calling parties to improve quality of the at least one communications signal for the test group;
measuring behavior data of the test group and the control group as a function of at least one metric describing the at least one communications signal; and
marketing the signal enhancement product to the service provider in part by informing the service provider of a difference between the behavior data of the test group and the behavior data of the control group due to the signal enhancement process.

28. The method of claim 27 wherein the difference in behavior data between the test group and the control group is free of human opinion.

29. The method of claim 27 wherein the behavior data includes call duration.

30. The method of claim 27 wherein the at least one metric describing the communications signals are noise level, speech level, or echo level.

31. The method of claim 27 wherein informing the service provider of a difference between call duration of the test group and the control group includes disclosing to the service provider statistically significant results determined at a confidence level of at least 95%.

32. The method of claim 27 wherein measuring call duration of the test group and the control group as a function of the at least one metric includes measuring call duration as a function of an aggregate of a plurality of metrics that describe the at least one communications signal.

33. The method of claim 27 wherein measuring call duration of the test group and the control group as a function of the at least one metric includes measuring call duration as a function of individual metrics of the at least one metric that describe the at least one communications signal.

34. The method of claim 27 wherein the service provider is a service provider associated with a wireless, wireline, or fiber optic communications network.
